(19) United States
(12) Patent Application Publication
(10) Pub. No.: US 2025/0180777 A1
(43) Pub. Date: Jun. 5, 2025

(54) METHODS AND SYSTEMS TO IDENTIFY PALEO STRESS REGIONS FOR DUAL POROSITY DUAL PERMEABILITY NUMERICAL SIMULATION

(71) Applicant: SAUDI ARABIAN OIL COMPANY, Dhahran (SA)

(72) Inventors: Otto Meza CAMARGO, Dhahran (SA); Karla Patricia OLVERA-CARRANZA, Dhahran (SA); Awan ANWAR, Dhahran (SA)

(73) Assignee: SAUDI ARABIAN OIL COMPANY, Dhahran (SA)

(21) Appl. No.: 18/530,057

(22) Filed: Dec. 5, 2023

(51) Int. Cl. G01V 20/00

(52) U.S. Cl. CPC G01V 20/00

(57) ABSTRACT

A computer-implemented method includes receiving a static fracture model and input data for a naturally fractured reservoir, obtaining changes in natural fracture orientations within the naturally fractured reservoir based on the static fracture model and the input data, obtaining variations of maximum horizontal stress directions within the naturally fractured reservoir based on principal stresses therein, determining one or more paleo-stress regions based on the changes in natural fracture orientations and the variations of maximum horizontal stress directions, and history matching each determined paleo-stress region to a known quantity of dynamic response based upon a known dynamic response, a historical data set, or a plurality of assumptions for flow characteristics.

### FIELD OF THE DISCLOSURE

The present disclosure relates generally to numerical simulations of hydrocarbon fracture systems and, more particularly, to methods and systems for identification of paleo-stress regions in Dual Porosity-Dual Permeability frameworks.

### BACKGROUND OF THE DISCLOSURE

Naturally fractured systems within hydrocarbon reservoirs commonly include spatial complexities that can necessitate 3D representations for numerical simulations. The naturally fractured systems can be simulated via dual porosity-dual permeability (DPDP) simulations. DPDP simulations can divide a simulation domain into a matrix of solid blocks representing sources and sinks and a fracture running between the solid blocks of the matrix for flow simulation. However, for the spatial complexities of naturally fractured systems, major faults, structural styles, mechanical stratigraphy, and in-situ stresses can alter the flow and conductivity of the system. Accordingly, the flow characteristics of each region within the naturally fractured system can differ from neighboring regions.

For performance of DPDP simulations, the solution of the numerical simulation can utilize a history matching practice (method) to map each region to a known behavior. The history matching practice can commonly employ a simulation grid including dynamic regions therein to capture the differing flow characteristics within the region of interest. History matching between a region of the naturally fractured system and a known behavior are commonly defined through operator experience, field operational criteria, or can be arbitrarily assigned until sufficient match is found. Current practices can include the use of history matching for validation of geomechanical models based on field operation data, as well as surface modeling for increased accuracy for history matching regions. However, the reliance on anecdotal or biased operator experience/personal knowledge can limit consistent simulations across different operators, and can decrease both repeatability and deployment across multiple reservoirs.

Accordingly, methods and systems for identification of structural stress zones for history matching are desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system includes memory to store machine-readable instructions, and one or more processors to access the memory and execute the machine-readable instructions. The machine-readable instructions include a structural geology module to extract one or more geological properties of a naturally fractured reservoir and sub-seismic lineaments from a static fracture model and input data, a clustering module to determine trends in properties of the sub-seismic lineaments and the naturally fractured reservoir, and a paleo-stress region module to define one or more paleo-stress regions within the static fracture model based on the trends.

In another embodiment, a computer-implemented method includes receiving a static fracture model and input data for a naturally fractured reservoir, performing one or more geological analyses on the static fracture model and input data to extract sub-seismic lineaments and geological properties of the naturally fractured reservoir, performing one or more clustering analyses on the static fracture model utilizing the sub-seismic lineaments and geological properties to generate trends within the static fracture model, identifying paleo-stress regions within the static fracture model as natural fracture regions based on the trends, and performing history matching on the identified paleo-stress regions for mapping historical data for dynamic simulation of the identified paleo-stress regions.

In a further embodiment, a computer-implemented method includes receiving a static fracture model and input data for a naturally fractured reservoir, obtaining changes in natural fracture orientations within the naturally fractured reservoir based on the static fracture model and the input data, obtaining variations of maximum horizontal stress directions within the naturally fractured reservoir based on principal stresses therein, determining one or more paleo-stress regions based on the changes in natural fracture orientations and the variations of maximum horizontal stress directions, and history matching each determined paleo-stress region to a known quantity of dynamic response based upon a known dynamic response, a historical data set, or a plurality of assumptions for flow characteristics.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a non-limiting example system that employs a paleo-stress region identification engine to identify paleo-stress regions in a naturally fractured reservoir and history-match the identified paleo-stress regions.

FIG. 2 is an example of a method for defining history matching regions within a naturally fractured reservoir via identification of paleo-stress regions.

FIG. 3 is an example of a method for identifying and history matching paleo-stress regions within a naturally fractured reservoir.

FIG. 4 is an example blended heatmap output of the seismic discontinuity analyzer.

FIG. 5 is an example borehole image and borehole image interpretation of the borehole image interpreter.

FIG. 6 is an example diagram illustrating fractures and breakouts determined via the borehole image interpreter.

FIG. 7 is an example damage zone output of the structural stress calculator.

FIG. 8 is an example structural framework output from the structural framework generator.

FIG. 9 is an example lineament output of the seismic clustering analyzer with extracted trends and lengths.

FIG. 10 is an example rose diagram output comparing fracture trends determined in the seismic clustering analyzer.

FIG. 11 is an example maximum stress direction plot output from the horizontal stress direction calculator.

FIG. 12 is an example comparison plot output of history-matched paleo-stress regions from the simulation engine.

FIG. 13 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to methods and systems for identifying paleo-stress regions in a dual porosity-dual permeability framework. Various embodiments described herein include systems and methods that can enable extraction of one or more geological properties within a naturally fractured reservoir for detection (or identification) of the paleo-stress regions in which a dynamic fluid response can be assumed throughout based upon historical data. The extracted geological properties can be used in determination or detection of sub-seismic lineaments, which define features within the naturally fractured reservoir. Each sub-seismic lineament can be analyzed, such that overall trends can be established to differentiate between lineament behavior between paleo-stress regions. The one or more geological properties can be extracted using one or more structural geology analyses, which can utilize different input data sources.

In some examples, the extracted geological properties can be utilized within one or more clustering analyses to define boundaries of the paleo-stress regions within the naturally fractured reservoir. After the paleo-stress regions have been identified, a history matching method can be implemented to match each paleo-stress region to a known dynamic response, a historical data set, or a plurality of assumptions for flow characteristics. Thus, the history matching method allows for an informed assumption of a dynamic response within the paleo-stress region. The identification and history matching of the paleo-stress regions improves an accuracy of dynamic simulations of the naturally fractured reservoir by not relying operator expertise, knowledge, or arbitrary assignments, as well as minimizes a simulation time.

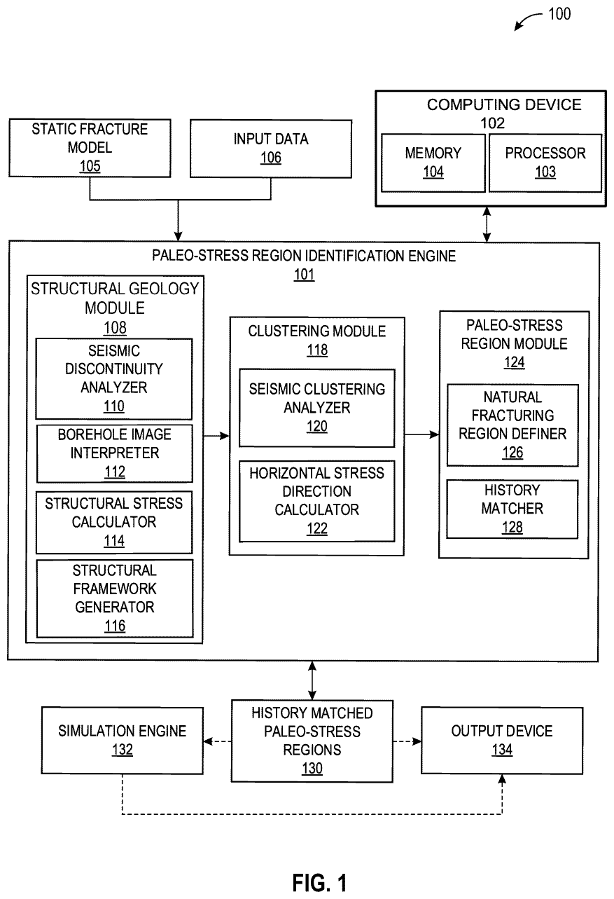

FIG. 1 is a block diagram of a non-limiting example system 100 that employs a paleo-stress region identification engine 101 to identify paleo-stress regions in a naturally fractured reservoir and history-match the identified paleo-stress regions. In some examples, the paleo-stress region identification engine 101 can be embodied as machine-readable instructions that can define a software plugin or tool, and thus in some instances can be embedded into another application (or software framework). For example, the paleo-stress region identification engine 101 can be implemented as a part of software used for modeling, or a stand-alone module that can be activated in response to the software, or by a user (e.g., using an input device, as disclosed herein).

The paleo-stress region identification engine 101 can be implemented using one or more modules, shown in block form in the drawings in the example of FIG. 1. The one or more modules can be in software or hardware form, or a combination thereof. In some examples, the paleo-stress region identification engine 101 can be implemented as machine-readable instructions for execution on a computing device 102, as shown in FIG. 1. The computing device 102 can include any computing device, for example, a desktop computer, a server, a controller, a blade, a mobile phone, a tablet, a laptop, a personal digital assistant (PDA), or other types of portable (or stationary) devices. The computing device 102 can include a processor 103 and a memory 104. By way of example, the memory 104 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 103 can be implemented, for example, as one or more processor cores. The memory 104 can store machine-readable instructions (e.g., the ROP engine 101) that can be retrieved and executed by the processor 103. Each of the processor 103 and the memory 104 can be implemented on a similar or a different computing platform. The computing platform could be implemented in a computing cloud and thus on a cloud computing architecture. In such a situation, features of the computing platform could be representative of a single instance of hardware or multiple instances of hardware executing across the multiple of instances (e.g., distributed) of hardware (e.g., computers, routers, memory, processors, or a combination thereof). Alternatively, the computing platform could be implemented on a single dedicated server or workstation.

In various embodiments, the paleo-stress region identification engine 101 can receive a static fracture model 105, such as a 3D physical model of a reservoir with a defined matrix and fracture therein. The paleo-stress region identification engine 101 can also receive input data 106 that can include borehole images, seismic volume data, geological properties, and/or, in some instances, other borehole data. The paleo-stress region identification engine 101 can utilize the input data 106 to determine regions within the static fracture model 105 for history matching.

In some embodiments, the paleo-stress region identification engine 101 can include a structural geology module 108. The structural geology module 108 can analyze geological characteristics within a wellbore based on the static fracture model 105 and the input data 106. In some embodiments, the structural geology module 108 can include a seismic discontinuity analyzer 110 to extract attributes of seismic discontinuities (or determine these attributes) from a 3D seismic volume of the static fracture model 105 and/or input data 106. The seismic discontinuities can reflect possible faults or sub-seismic lineaments that can define a structure of the reservoir. In some embodiments, the seismic discontinuity analyzer 110 can implement extraction techniques to determine model attributes: a dip, a tensor, and a semblance of the 3D seismic volume. The dip can be used to detect changes in orientation, the tensor can be used to detect changes in amplitude, and the semblance may detect changes in phase for seismic readings. The seismic discontinuity analyzer 110 can combine the model attributes to generate a blended heatmap or cyan-magenta-yellow map for further extraction of lineaments. Using the model attributes for (or of) the 3D seismic volume, lineaments of the region can be extracted and further analyzed.

The structural geology module 108 can include a borehole image interpreter 112 to extract natural fracture characteristics of a borehole of interest. The borehole image interpreter 112 can receive resistive or sonic images of the borehole of the input data 106 to determine a fracture type, a dip angle, a dip azimuth, and a well-level intensity of natural fractures, which can be referred to as natural fracture characteristics. The borehole image interpreter 112 can in some instances determine an apparent fracture aperture for the natural fracture. In some embodiments, the borehole image interpreter 112 can receive core-plug measurements of the input data 106, such that the apparent fracture aperture can be calibrated. In some embodiments, the borehole image interpreter 112 can further define (or identify) an in-situ stress regime within the borehole based on the borehole images. Damage zone area properties including hole shape and indications of mechanical failure, such as breakouts or drilling-induced tensile fractures, can be accordingly determined and extracted by the borehole image interpreter 112. The attributes of the in-situ stress regime and damage zone areas can be utilized for wellbore stability models to constrain models of the stress regime in further simulations.

The structural geology module 108 can further include a structural stress calculator 114 to determine attributes for controlling the structure and flow paths within the natural fractures. The structural stress calculator 114 determines a paleo-stress regime that could generate the present natural fractures, as well as the current in-situ stress regime of the borehole. For example, the structural stress calculator 114 utilizes the damage zone areas to extract the paleo-stress regime. In some instances, the structural stress calculator 114 can utilizes three principal stress magnitudes that can be calculated based on clastic properties, rock strength, and pore pressure within a poro-clastic stress model. The system 100 can further utilize the three principal stress magnitudes to determine and model an in-situ stress regime.

In some embodiments, the structural geology module 108 can further include a structural framework generator 116 to generate a volume-based model of the reservoir. The structural framework generator 116 can receive seismic interpretations of the formation and formation well top readings, and can extract surfaces and faults therefrom to generate a structural framework. The structural framework can enable structural views of the region and its deformational history. In some embodiments, the structural framework generator 116 can provide a new (or updated) volume-based model which can include fault features such as the throw, extension, and shape of each fault. Each extracted surface and fault, and features thereof, within the volume-based model can be utilized by the paleo-stress region identification engine 101 for further analysis.

The paleo-stress region identification engine 101 can further include a clustering module 118 to receive model attributes and lineaments extracted by the structural geology module 108 for further analysis. The clustering module 118 can determine regions wherein extracted sub-seismic lineaments, natural fracture characteristics, and stress orientation indicators shift and change. In some embodiments, the clustering module 118 can include a seismic clustering analyzer 120 that can utilize sub-seismic lineaments to extract lineament properties. The sub-seismic lineaments can include several properties such as lineament length, dip angle, dip azimuth, and lineament quality. The seismic clustering analyzer 120 can extract these properties to determine trends or distributions within the reservoir area. In some examples, the seismic clustering analyzer 120 can analyze the trends or distributions to determine relationships within the region and thus to determine a difference between a natural fracture and further geological features. The seismic clustering analyzer 120 can determine coherent relationships between the trends within a region to identify the natural fracture, while erratic or random trends can denote a further geological feature. Sub-seismic lineaments can thus be used to capture possible faults or fault trends, such that boundaries between regions can be drawn within the reservoir area. The seismic clustering analyzer 120 can utilize the natural fractures extracted via the borehole image interpreter 112 to further determine regional constraints and subs-seismic lineament trends. Through the combination of the trends found via the results of the borehole image interpreter 112 and the sub-seismic lineament properties, the seismic clustering analyzer 120 can enable differentiation of natural fracture trends from other geological features within the reservoir area.

In some embodiments, the clustering module 118 can further include a horizontal stress direction calculator 122. The horizontal stress direction calculator 122 can differentiate between natural fracture trends and further geological phenomenon within the reservoir area. The horizontal stress direction calculator 122 can determine a maximum horizontal stress within the reservoir area, and can enable analysis of a tectonic response versus pore pressure depletion within the reservoir area. For tectonic responses, trends of the maximum horizontal stress directions can indicate different structural paleo-stress regions. The structural paleo-stress regions can be differentiated via changes in maximum horizontal stress direction trends, such that each paleo-stress region can have a differing directional trend from neighboring regions. In some embodiments, the horizontal stress direction calculator 122 can further generate a 4D mechanical earth model for determination of pore pressure over time. In these embodiments, the 4D mechanical earth model can enable differentiation between tectonic response and pore pressure depletion as a source of changing maximum horizontal stress direction. In these embodiments, a difference in directional stresses can be attributed to depletion, while a constant stress direction can be attributed to a tectonic response within the formation.

The paleo-stress region identification engine 101 can further include a paleo-stress region module 124. The paleo-stress region module 124 can utilize the sub-seismic lineaments, the natural fracture trends, and the maximum horizontal stress directions to define a plurality of paleo-stress regions within the reservoir area. The paleo-stress region module 124 can include a natural fracturing region definer 126 that can utilize sub-seismic lineaments, natural fracture trends, and maximum horizontal stress directions from the clustering module 118 to differentiate between natural fracturing regions and geological phenomena such as faults. A natural fracturing region definer 126 of the module 124 can be used to analyze trends in natural fracture properties, such as orientation of stresses, number of differing trends, and flow paths generated therefrom in the determination of natural fracturing regions. The natural fracturing region definer 126 can utilize the provided information to determine and define specific regions of the reservoir area as paleo-stress regions in which dynamic behavior is similar throughout.

In some embodiments, the paleo-stress region module 124 can further include a history matcher 128 to assign the paleo-stress regions as history match regions. The paleo-stress regions previously identified within the natural fracturing region definer 126 can be utilized as history match regions for dynamic simulations on the reservoir area. The history match regions can be utilized in generalizing the paleo-stress region for dynamic simulation through analogous regions. As an example, a similar naturally fractured region which has been dynamically simulated can be utilized as a surrogate for the history match region to reduce a computational load for the simulation (e.g., requiring less simulation cycles and thus reducing a computational intensity of the computing device). In a further example, the similar naturally fractured region can be utilized in assigning of constants or assumptions previously determined in dynamic simulations. The history matcher 128 can utilize the determined paleo-stress regions as history match regions without operator expertise or experience, as required by standard conventional (dynamic simulation) systems.

As shown in FIG. 1, the paleo-stress region identification engine 101 can provide history matched paleo-stress regions 130 via the history matcher 128. The history matched paleo-stress regions 130 can include a plurality of paleo-stress regions identified within the static fracture model 105 for dynamic simulation using historical data. The history matched paleo-stress regions 130 can enable dynamic simulations of the reservoir area with a lower computational load and runtime than traditional simulations. Further, the history matched paleo-stress regions 130 can be generated with a higher degree of confidence than conventional history match regions that rely on operator expertise or experience for arbitrary assignment.

In some embodiments, the system 100 can include a simulation engine 132 that can receive the history matched paleo-stress regions 130 for dynamic simulations. The simulation engine 132 can perform dual-porosity dual-permeability numerical simulations to depict irregular fluid flow behavior through naturally fractured reservoirs. The simulation engine 132 can utilize the history matched paleo-stress regions 130 to maintain geological consistency through subsequent simulation processes, and can provide sectorized geological insight on abnormal productivity, water encroachment, and channelization across the reservoir area. Through the use of history matched paleo-stress regions 130, the simulation engine 132 can expedite the solution process while ensuring quality matching and assignment of flow parameters.

In some embodiments, the system 100 can further include an output device 134 (e.g., a display, a computer, etc.) that can receive the history matched paleo-stress regions 130 or an output of the simulation engine 132 for rendering to a user. The output device 134 can enable visual verification and validation of any outputs within the system 100. Further, the connected display 134 may visualize any results generated via the paleo-stress region identification engine 101 or simulation engine 132 for further modification of any parameters therein. The system 100 can thus produce higher quality simulation results on naturally fractured reservoirs via the definition of paleo-stress regions and history matching of said regions. The outputs of these simulations can be used for optimizing well locations, and, in some instances, modify drilling and gas injection operations. For example, the output of the simulations can be used to modify or change a well location (or optimize a selected well location). The output of the simulations can be provided to well planning, gas injection, or drilling operation software for optimization and planning of further operations. Furthermore, risks within naturally fractured reservoirs can be reduced via accurate modeling of the reservoir and included faults or imperfections by the system 100.

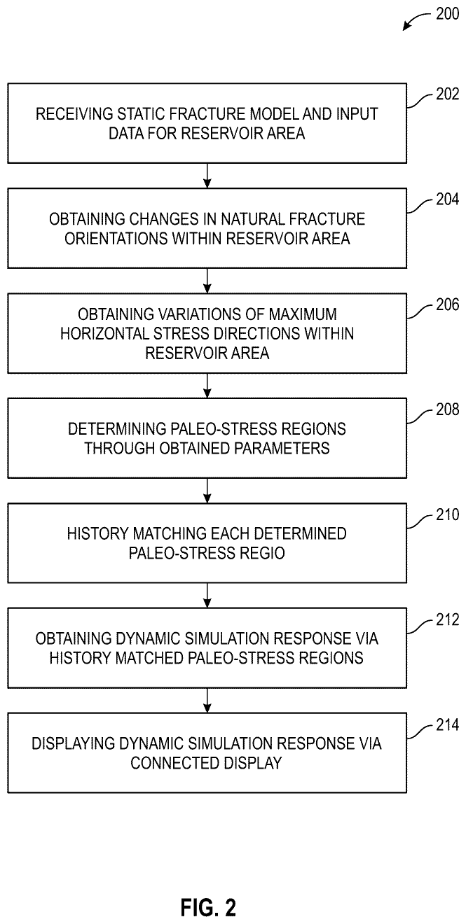

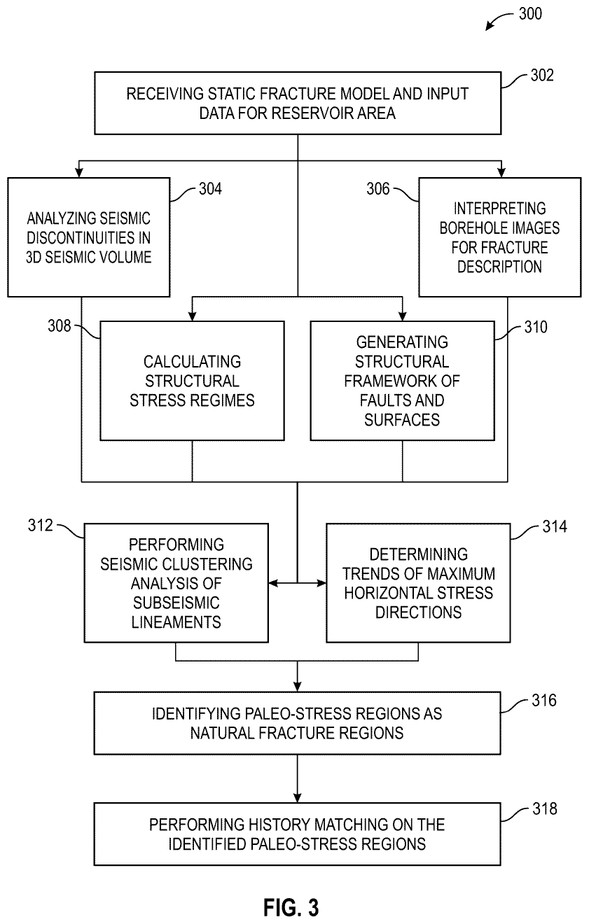

In view of the structural and functional features described above, example methods will be better appreciated with reference to FIG. 1. While, for purposes of simplicity of explanation, the example methods of FIG. 2-3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 2 is an example of a method 200 for defining history matching regions within a naturally fractured reservoir via identification of paleo-stress regions. The method 200 can be implemented by the system 100, as shown in FIG. 1. Thus, reference can be made to the example of FIG. 1 in the example of FIG. 2. The method 200 can begin at 202 with receiving a static fracture model (e.g., the static fracture model 105) and one or more pieces of input data (e.g., the input data 106) for the reservoir area. The static fracture model can include a 3D representation of the naturally fractured reservoir, while the one or more pieces of input data can include borehole images, parameters of the borehole or reservoir area, seismic readings of the reservoir area, or any further data that can be utilized in geological calculations and analysis.

The method 200 can further include obtaining changes in the natural fracture orientations at 204. The changes in the natural fracture orientations can be found via various components of structural geology (e.g., via the structural geology module 108). The changes in natural fracture orientations can be found via analysis of seismic discontinuities (e.g., via the seismic discontinuity analyzer 110), via calculation of structural stresses (e.g., via the structural stress calculator 114), or via any number of geological concepts without departing from the scope of this disclosure. The natural fracture orientation can be determine at 204 and analyzed to further determine any regions or boundaries in which the natural fracture orientations can shift. These shifts or changes in the natural fracture orientations can denote boundaries of paleo-stress regions, such that flowpaths and pores can be defined therethrough.

The method 200 can further include obtaining variations of a maximum horizontal stress directions throughout the naturally fractured reservoir at 206. Obtaining variations of the maximum horizontal stress direction at 206 can entail calculation of the horizontal stress directions within the reservoir (e.g., via the horizontal stress direction calculator 122). The maximum horizontal stress directions can be utilized in further analysis of paleo-stress region boundaries, such that variations in the maximum horizontal stress direction can denote the boundary between two or more paleo-stress regions. As the paleo-stress regions to be defined within example method 200 are to be relatively uniform throughout, the variations obtained at 206 can demarcate paleo-stress regions that can be isolated from neighboring regions.

The method 200 can further include determining paleo-stress regions at 208 through the variations of maximum horizontal stress directions and changes in natural fracture orientation previously found. The paleo-stress regions can be identified at 208 via definition of natural fracturing regions within the reservoir (e.g., via the natural fracturing region definer 126). The paleo-stress regions identified at 208 can share properties throughout each region, such that assumptions and comparisons can be made within larger regional structures for dynamic simulation thereof. Accordingly, the method 200 can further include history matching each identified paleo-stress region at 210. The history matching of each identified paleo-stress region at 210 can include the use of historical data or informed assumptions for each paleo-stress region, such that the dynamic simulation of the reservoir can be expedited and performed with a greater insurance of quality.

The method 200 can further include obtaining a dynamic simulation response at 212 using the history matched paleo-stress regions (e.g., the history matched paleo-stress regions 130). The history matched paleo-stress regions may be utilized by a simulation engine (e.g., the simulation engine 132) for performance of a dynamic simulation as discussed above. Using a history matching process with the identified paleo-stress regions can reduce iterative performances of simulations, such that the paleo-stress regions can be identified and mapped to known behaviors. In some embodiments, the method 200 can further include displaying the dynamic simulation response at 214 via a connected display or user interface. Displaying the dynamic simulation response at 214 can enable visual verification of the performed simulation, and can enable an operator to see and adjust any performance of the dynamic simulation.

FIG. 3 is an example of a method 300 for identifying and history matching paleo-stress regions within a naturally fractured reservoir (e.g., via the paleo-stress region identification engine 101). The method 300 can be implemented by the system 100, as shown in FIG. 1. Thus, reference can be made to the example of FIG. 1 in the example of FIG. 3. The method 300 can begin at 302 with receiving a static fracture model (e.g., the static fracture model 105) and one or more pieces of input data (e.g., the input data 106) for the reservoir area.

The method 300 can include one or more structural geology analyses at 304-310 (e.g., via the structural geology module 108), such that the input static fracture model and input data can be pre-processed for extraction of sub-seismic lineaments and corresponding properties/information. The method 300 can include analyzing seismic discontinuities within a 3D seismic volume at 304 (e.g., via the seismic discontinuity analyzer 110). The 3D seismic volume can include both the static fracture model, or a piece of input data which includes seismic imaging of the reservoir area. The analysis of seismic discontinuities at 304 can include extraction of the tensor, semblance, and dip of the 3D seismic volume and corresponding to the changes in amplitude, phase, and orientation of the 3D seismic volume, respectively. The analysis of the seismic discontinuities at 304 can further include extraction of lineaments within the 3D seismic volume via the tensor, semblance, and dip.

The method 300 can include interpreting borehole images for fracture descriptions at 306 (e.g., via the borehole image interpreter 112). The interpretation of the borehole images at 306 can include receiving one or more borehole images of either sonic or resistive imaging provided as a piece of input data at 302. The borehole images can enable extraction of natural fracture type, dip angle, dip azimuth, and intensity at well level. Accordingly, the borehole images can be interpreted to extract a plurality of relevant properties to be utilized further herein. In some embodiments, interpretation of borehole images at 206 can further include defining in-situ stress regime orientations in the reservoir area via the provided images and indications of mechanical failure. Accordingly, a wellbore stability model can be developed for constraining of the stress regime module using the interpreted borehole images.

The method 300 can include calculating structural stress regimes at 308 (e.g., via the structural stress calculator 114). The calculation of the structural stress regimes at 308 can include defining a paleo-stress regime that could generate the existing natural fractures seen in the static fracture model and pieces of input data. The calculation of the structural stress regimes at 308 can further include defining the current in-situ stress regime within the reservoir area based upon current measurements and modeling. These calculations can include analysis of damage zones surrounding a natural fracture, such that damaged earth can appear surrounding the fracture and can dissipate away from the natural fracture. The determination of damage zones along with the calculations at 308 can further utilize magnitudes of the three principal stresses. In some embodiments, these principal stresses can be calculated using elastic properties, rock strength, and pore pressure within a poro-elasticity stress model.

The method 300 can include generating structural framework of faults and surfaces at 310 (e.g., via the structural framework generator 116). The structural framework generated at 310 can be defined via the surfaces and faults of seismic interpretations and formation well tops, such that a volume-based model can be constructed. The volume-based model can include fault features such as throw, extension, and shape of the fault for determination of flowpaths and dynamic responses therein.

Following one or more of the structural geology analyses at 304-310, any extracted sub-seismic lineaments, properties, and further information can be utilized at 312 and 314 for the performance of clustering analyses (e.g., via the clustering module 118). These clustering analyses can enable the determination of paleo-stress regions based upon overall trends within the reservoir areas and denoted sub-regions therein. The method 300 can include performing seismic cluster analysis of sub-seismic lineaments at 312 (e.g., via the seismic clustering analyzer 120). The seismic cluster analysis performed at 312 can include determination of length, dip angle, dip azimuth, and lineament quality for the region or sub-region of interest. These parameters of the sub-seismic lineaments can be utilized in determining overall trends or distributions of the reservoir area, such that boundaries and borders of a region can be identified. The method 300 can further include determining trends of maximum horizontal stress directions at 314 (e.g., via the horizontal stress direction calculator 122). The trends of the maximum horizontal stress directions can denote either a tectonic response to present faults, or pore pressure depletion within the reservoir area. The use of these trends can enable the differentiation between these two scenarios, and can further enable determination of specific paleo-stress regions based upon variations in these trends between geological areas.

Using the one or more clustering analyses performed at 312 and 314, the method 300 can include identifying paleo-stress regions within the static fracture model as natural fracture regions at 316 (e.g., via the natural fracturing region definer 126). Based upon the trends of the maximum horizontal stress directions and the sub-seismic lineament property trends, regions of the static fracture model can be differentiated into paleo-stress regions. These paleo-stress regions can denote an isolated or uniform section of the reservoir area in which a dynamic response can be expected. The differences in dynamic responses between the paleo-stress regions can present as differences in orientations, trends, and flow paths throughout the paleo-stress region as a whole.

The method 300 can further include performing history matching on the identified paleo-stress regions at 318 (e.g., via the history matcher 128). The history matching of the identified paleo-stress regions at 318 can utilize the differences in dynamic responses observed at 316, such that the dynamics of the region can be mapped to a known behavior or assumptions. Based upon these dynamics, fluid flow behavior can be expected within a paleo-stress region as compared to the historical data, such that differing water breakthrough and flow path development can be assumed. The dynamic responses of the identified paleo-stress regions can be further utilized in well planning, gas injection operations, and drilling operations for optimization of extraction operations. Through the method 300, detection of the paleo-stress regions, as well as history matching thereof, can be performed without reliance on operator expertise, experience, or arbitrary assignments.

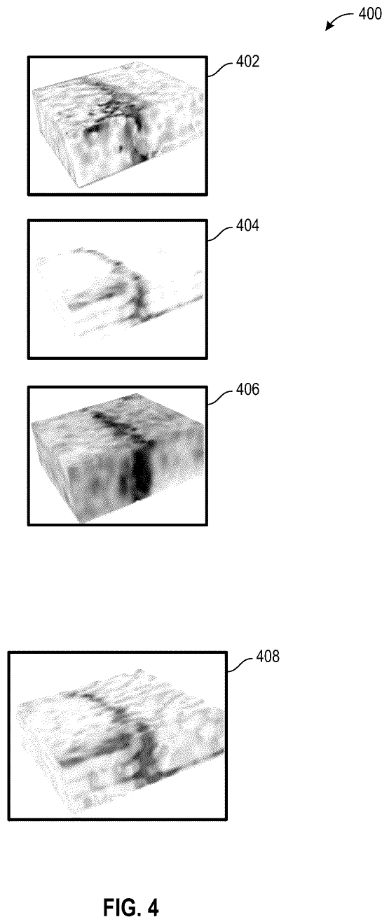

In view of the structural and functional features, as well as example methods, described above, example outputs will be better appreciated with reference to FIG. 1-3. Accordingly, FIGS. 4-10 illustrate example interim outputs of the system 100 and methods 200 and 300 described herein.

FIG. 4 is an example blended heatmap output 400 of the seismic discontinuity analyzer 110. The blended heatmap output 400 includes a dip heatmap 402, a semblance heatmap 404, and a tensor heatmap 406. Each of the heatmaps 402-406 can be utilized in combination to extract a sub-seismic lineament and/or generate a rose diagram of the discontinuities within the naturally fractured reservoir. The blended heatmap output 400 further includes a blended heatmap 408 incorporating results of each heatmap 402-406 for determining and extracting these discontinuities. Through blending of the heatmaps 402-406, the blended heatmap 408 can enable detection of zones in which changes in orientation, phase, and amplitude of seismic discontinuities overlap.

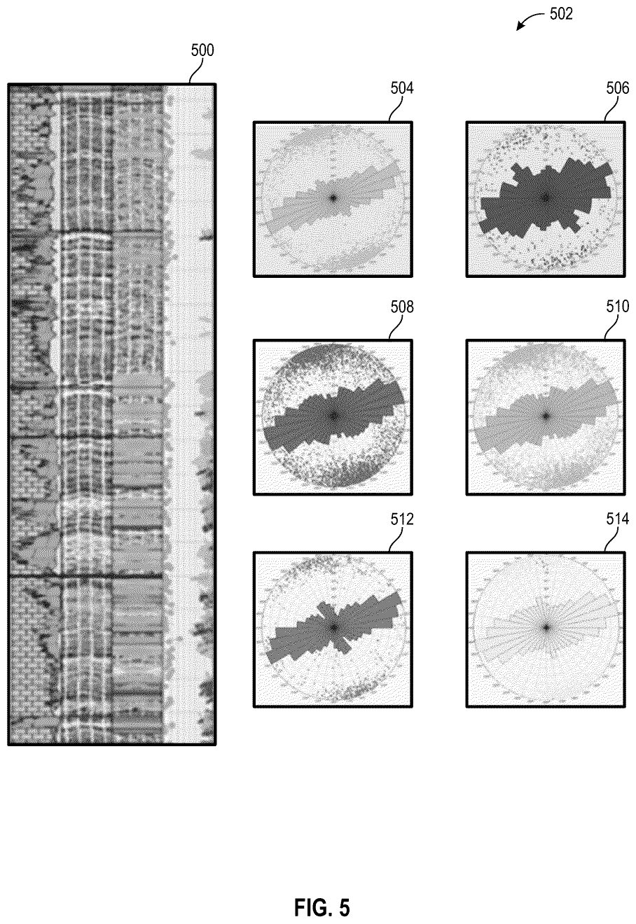

FIG. 5 is an example borehole image 500 and borehole image interpretation 502 of the borehole image interpreter 112. The borehole image 500 can be vertically represented, as shown in FIG. 5, such that the depth of the borehole increases as the image extends down the y-axis. Various characteristics of the borehole image 500 can be extracted by the borehole image interpreter 112, such that the borehole image interpretation 502 is generated. The borehole image interpretation 502 includes a plurality of fracture types represented by rose diagrams for each natural fracture type. The fracture types can include conductive fractures 504, mega fractures 506, partial conductive fractures 508, bed bound fractures 510, resistive fractures 512, partial resistive fractures 514, and any combination thereof. The rose diagrams for each natural fracture type can further include dip angles, azimuths, and intensities at the well level and can be used in determining the apparent fracture aperture.

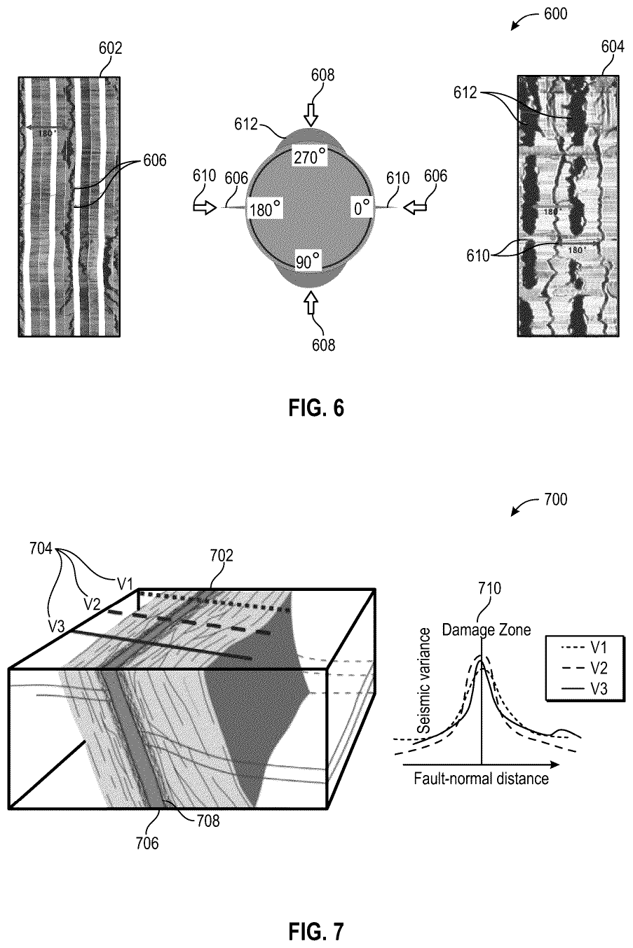

FIG. 6 is an example diagram 600 illustrating fractures and breakouts determined via the borehole image interpreter 112. The diagram 600 includes a first wellbore image 602 representing a drilling-induced tensile fracture, and a second wellbore image 604 representing simultaneous wellbore failure in compression and in tension for demonstrative purposes. In both wellbore images 602 and 604, the maximum horizontal stress orientations 606, as well as the minimum horizontal stress orientations 608, can be mapped to the wellbore image for defining the in-situ stress regime orientation. The mapping of these horizontal stress orientations 606 and 608 can correspond to tensile fracture locations 610 and breakout locations 612 respectively.

FIG. 7 is an example damage zone output 700 of the structural stress calculator 114. The damage zone output 700 is shown for a normal fault system, such that a fault zone diagram 702 may represent the system. The fault zone diagram 702 can include three variance samples 704 (V1-V3) for sampling across the fault zone. The variance samples 704 can cross over a fault core 706 within the fault zone diagram 702, and further cross over the damage zone 708 surrounding the fault core 706. These variance samples 704 can be mapped to a seismic variance plot 710 such that the seismic variance of each variance sample 704 is represented across the distance from the fault core. The damage zone distribution of the seismic variance plot 710 can be utilized in determination of natural fracture systems compared to alternative fault distributions.

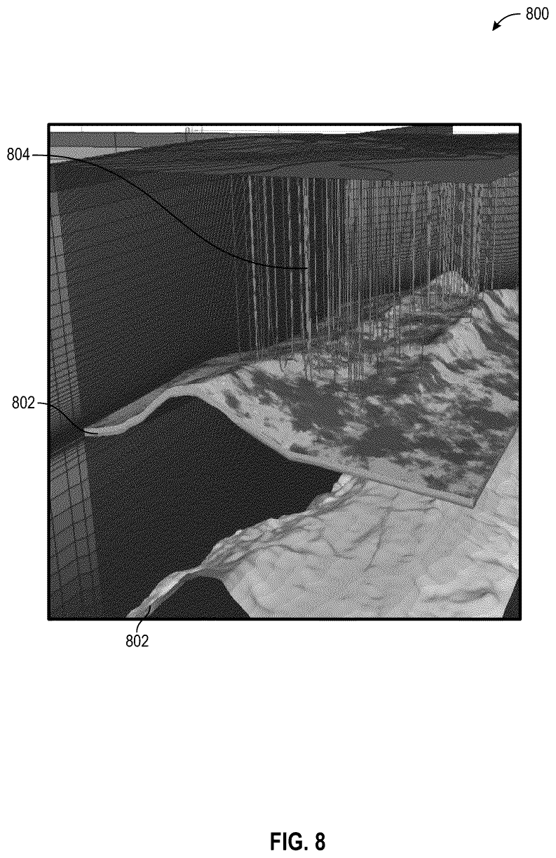

FIG. 8 is an example structural framework 800 output from the structural framework generator 116. The structural framework 800 can include one or more surfaces 802 which are obtained via seismic interpretation and defined within the structural framework generator. Further, a plurality of faults 804 can be included within the structural framework 800 which can include the throw, extension, and shapes of each fault.

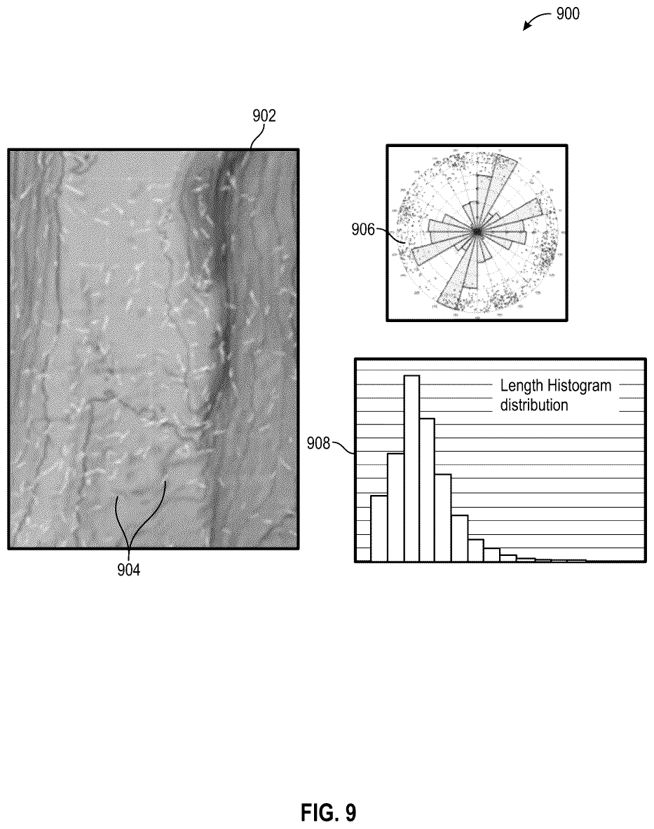

FIG. 9 is an example lineament output 900 of the seismic clustering analyzer 120 with extracted trends and lengths. The lineament output 900 can include an extracted lineament map 902 displaying each extracted lineament 904 within the region of interest. The length and orientation of each extracted lineament 904 can be further extracted within the seismic clustering analyzer 120 to produce rose diagram 906 and histogram 908 to represent the distribution of extracted lineaments 904. The rose diagram 906 can represent the general orientation trend of the extracted lineaments 904 to provide an overall orientation trend. Similarly, the histogram 908 can represent the distribution of lengths for the extracted lineaments 904.

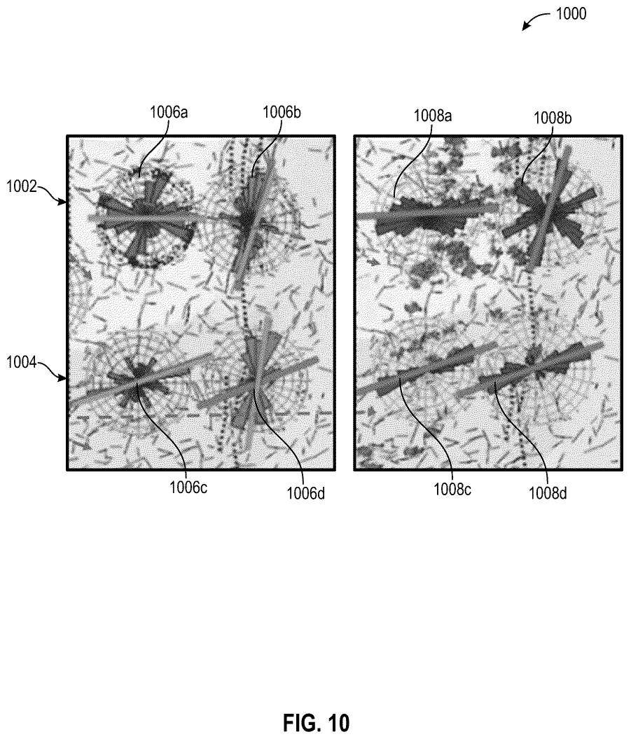

FIG. 10 is an example rose diagram output 1000 comparing fracture trends determined in the seismic clustering analyzer 120. The rose diagram output 1000 can be seen split into an upper section 1002 representing first paleo-stress region, and a lower section 1004 representing a second paleo-stress region. Each section 1002 and 1004 can include one or more lineament rose diagrams 1006 and one or more borehole image rose diagrams 1008. The inclusion of both lineament rose diagrams 1006 and borehole image rose diagrams 1008 can enable the comparison of fracture sets within the paleo-stress regions. This comparison can advise whether natural fracture trends or alternative fractures are present, as natural fracture trends can include similar orientation between the rose diagrams 1006 and 1008. Further, including multiple rose diagrams 1006 and 1008 for each section 1002 and 1004 can enable analysis of the orientations across the paleo-stress regions and enhance granularity.

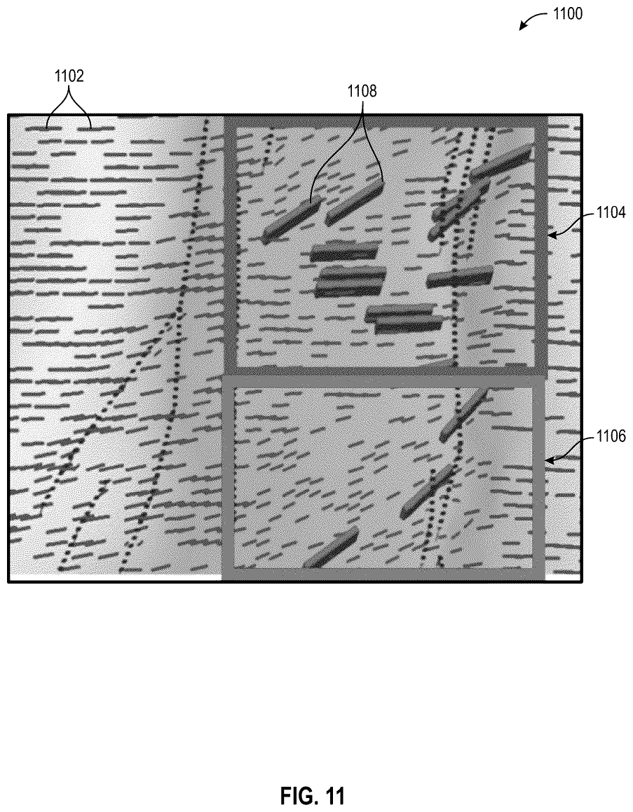

FIG. 11 is an example maximum stress direction plot output 1100 from the horizontal stress direction calculator 122. The maximum stress direction plot output 1100 can display perturbations within the maximum horizontal stress directions 1102, such that paleo-stress regions 1104 and 1106 can be defined. As shown, the perturbed directions 1108 are present within the paleo-stress regions 1104 and 1106 denoting possible faults or pore depletion within, particularly when compared to an overall trend of the maximum horizontal stress directions 1102. The horizontal stress direction calculator 122 can utilize maximum horizontal stress directions to thus determine and verify paleo-stress regions for history matching.

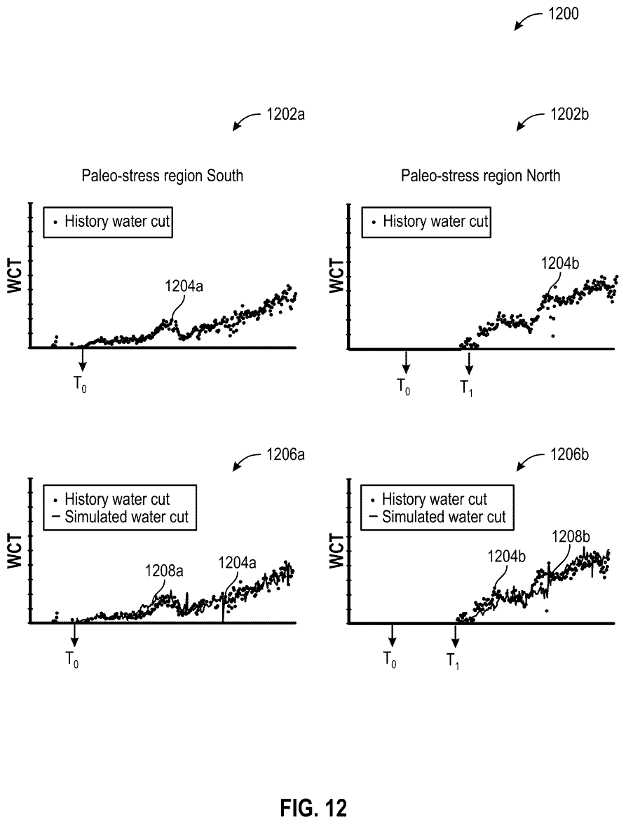

FIG. 12 is an example comparison plot output 1200 of history-matched paleo-stress regions from the simulation engine 132. The comparison plot output 1200 can include a historical plots 1202a and 1202b which show historical water breakthrough data 1204a and 1204b in separate paleo-stress regions over time. The comparison plot output 1200 can further include simulated plots 1206a and 1206b for each paleo-stress region with compared historical data. The simulated plots 1206a and 1206b can include simulated water breakthrough data 1208a and 1208b overlaid with the historical water breakthrough data 1204a and 1204b. The comparison between the simulated water breakthrough data 1208 and historical water breakthrough data 1204 shows both the reliability of history matching in paleo-stress regions and the differences in flow behavior between different paleo-stress regions that can be lost without proper history matching or simulations.

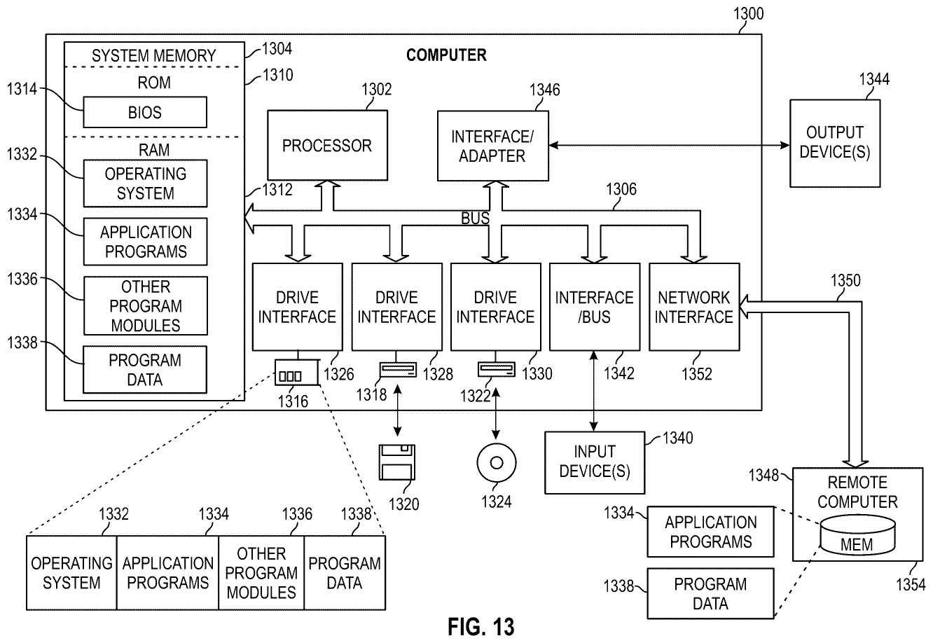

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 13. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 13 illustrates one example of a computer system 400 that can be employed to execute one or more embodiments of the present disclosure. Computer system 1300 can be implemented on one or more general purpose networked computer systems, embedded computer systems, routers, switches, server devices, client devices, various intermediate devices/nodes or standalone computer systems. Additionally, computer system 1300 can be implemented on various mobile clients such as, for example, a personal digital assistant (PDA), laptop computer, pager, and the like, provided it includes sufficient processing capabilities.

Computer system 1300 includes processing unit 1302, system memory 1304, and system bus 1306 that couples various system components, including the system memory 1304, to processing unit 1302. System memory 1304 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1302. System bus 1306 may be any of several types of bus structure including a memory bus or memory controller, a peripheral bus, and a local bus using any of a variety of bus architectures. System memory 1304 includes read only memory (ROM) 1310 and random access memory (RAM) 1312. A basic input/output system (BIOS) 1314 can reside in ROM 1310 containing the basic routines that help to transfer information among elements within computer system 1300.

Computer system 1300 can include a hard disk drive 1316, magnetic disk drive 1318, e.g., to read from or write to removable disk 1320, and an optical disk drive 1322, e.g., for reading CD-ROM disk 1324 or to read from or write to other optical media. Hard disk drive 1316, magnetic disk drive 1318, and optical disk drive 1322 are connected to system bus 1306 by a hard disk drive interface 1326, a magnetic disk drive interface 1328, and an optical drive interface 1330, respectively. The drives and associated computer-readable media provide nonvolatile storage of data, data structures, and computer-executable instructions for computer system 1300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 1310, including operating system 1332, one or more application programs 1334, other program modules 1336, and program data 1338. In some examples, the application programs 1334 can include the structural geology module 108, the clustering module 118, the paleo-stress region module 124, and any sub-programs thereof, and the program data 1338 can include extracted lineament information, calculated reservoir properties, the static fracture model, borehole images, and additional input data. The application programs 1334 and program data 1338 can include functions and methods programmed to identify paleo-stress regions of a naturally fractured reservoir and history match the said regions with known behaviors, such as shown and described herein.

A user may enter commands and information into computer system 1300 through one or more input devices 1340, such as a pointing device (e.g., a mouse, touch screen), keyboard, microphone, joystick, game pad, scanner, and the like. For instance, the user can employ input device 1340 to edit or modify input data, lineament orientations, performed calculations, or to manipulate visualized results. These and other input devices 1340 are often connected to processing unit 1302 through a corresponding port interface 1342 that is coupled to the system bus, but may be connected by other interfaces, such as a parallel port, serial port, or universal serial bus (USB). One or more output devices 1344 (e.g., display, a monitor, printer, projector, or other type of displaying device) is also connected to system bus 1306 via interface 1346, such as a video adapter.

Computer system 1300 may operate in a networked environment using logical connections to one or more remote computers, such as remote computer 1348. Remote computer 1348 may be a workstation, computer system, router, peer device, or other common network node, and typically includes many or all the elements described relative to computer system 1300. The logical connections, schematically indicated at 1350, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1300 can be connected to the local network through a network interface or adapter 1352. When used in a WAN networking environment, computer system 1300 can include a modem, or can be connected to a communications server on the LAN. The modem, which may be internal or external, can be connected to system bus 1306 via an appropriate port interface. In a networked environment, application programs 1334 or program data 1338 depicted relative to computer system 1300, or portions thereof, may be stored in a remote memory storage device 1354.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

Embodiments disclosed herein include:
A. A system comprising: memory to store machine-readable instructions; and one or more processors to access the memory and execute the machine-readable instructions, the machine-readable instructions comprising: a structural geology module to extract one or more geological properties of a naturally fractured reservoir and sub-seismic lineaments from a static fracture model and input data; a clustering module to determine trends in properties of the sub-seismic lineaments and the naturally fractured reservoir; and a paleo-stress region module to define one or more paleo-stress regions within the static fracture model based on the trends.
B. A computer-implemented method comprising: receiving a static fracture model and input data for a naturally fractured reservoir; performing one or more geological analyses on the static fracture model and input data to extract sub-seismic lineaments and geological properties of the naturally fractured reservoir; performing one or more clustering analyses on the static fracture model utilizing the sub-seismic lineaments and geological properties to generate trends within the static fracture model; identifying paleo-stress regions within the static fracture model as natural fracture regions based on the trends; and performing history matching on the identified paleo-stress regions for mapping historical data for dynamic simulation of the identified paleo-stress regions.
C. A computer-implemented method comprising: receiving a static fracture model and input data for a naturally fractured reservoir; obtaining changes in natural fracture orientations within the naturally fractured reservoir based on the static fracture model and the input data; obtaining variations of maximum horizontal stress directions within the naturally fractured reservoir based on principal stresses therein; determining one or more paleo-stress regions based on the changes in natural fracture orientations and the variations of maximum horizontal stress directions; and history matching each determined paleo-stress region to a known quantity of dynamic response based upon a known dynamic response, a historical data set, or a plurality of assumptions for flow characteristics.

Each of embodiments A through C may have one or more of the following additional elements in any combination: Element 1: wherein the paleo-stress region module generates history matched paleo-stress regions including a dynamic behavior or one or more fluid flow assumptions for the one or more paleo-stress regions. Element 2: wherein the machine-readable instructions cause the processor to further: perform one or more dynamic simulations on the static fracture model with the defined one or more paleo-stress regions. Element 3: wherein the input data includes a borehole image and the structural geology module is to extract sub-seismic lineaments from the borehole image. Element 4: wherein the clustering module is to determine the trends based on the extracted sub-seismic lineaments. Element 5: wherein the structural geology module calculates principal stress magnitudes using a poro-elasticity stress model. Element 6: wherein the clustering module calculates a maximum horizontal stress direction based on the principal stress magnitudes to produce directional trends within the naturally fractured reservoir for defining the one or more paleo-stress regions. Element 7: wherein the one or more geological analyses includes analyzing seismic discontinuities in a three-dimensional (3D) seismic volume to identify the sub-seismic lineaments. Element 8: wherein the one or more geological analyses includes interpreting a borehole image received as the input data to extract a natural fracture type, a dip angle, a dip azimuth, and/or an intensity at well level within the naturally fractured reservoir. Element 9: wherein the borehole image is a seismic image or a resistive image of the naturally fractured reservoir.

Element 10: wherein the one or more geological analyses includes calculating structural stress regimes within the naturally fractured reservoir through determination of principal stresses within the naturally fractured reservoir. Element 11: wherein elastic properties, a rock strength, and a pore pressure within a poro-elasticity stress model is used to determine the principal stresses. Element 12: wherein the one or more geological analyses includes generating a structural framework of faults and surfaces to define a volume-based model for identification of paleo-stress regions therein. Element 13: wherein the paleo-stress regions are identified based on maximum horizontal stress direction trends and sub-seismic lineament property trends. Element 14: further comprising: simulating flow within the naturally fractured reservoir to obtain dynamic simulation responses within the static fracture model via history matched paleo-stress regions. Element 15: wherein, the dynamic simulation responses are output to well planning, gas injection, or drilling operation software for optimization of extraction operations in the naturally fractured reservoir. Element 16: further comprising: causing the dynamic simulation responses within the static fracture model to be displayed on an output device. Element 17: wherein the changes in natural fracture orientations and variation of maximum horizontal stress directions are determined based on properties extracted using an analysis of seismic discontinuities, an interpretation of a borehole image, a calculation of structural stresses, and/or a generation of a structural framework.

By way of non-limiting example, exemplary combinations applicable to A through C include: Element 1 with Element 2; Element 3 with Element 4; Element 5 with Element 6; Element 8 with Element 9; Element 10 with Element 11; Element 14 with Element 15; and Element 14 with Element 16.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system comprising:
memory to store machine-readable instructions; and
one or more processors to access the memory and execute the machine-readable instructions, the machine-readable instructions comprising:
a structural geology module to extract one or more geological properties of a naturally fractured reservoir and sub-seismic lineaments from a static fracture model and input data;
a clustering module to determine trends in properties of the sub-seismic lineaments and the naturally fractured reservoir; and
a paleo-stress region module to define one or more paleo-stress regions within the static fracture model based on the trends.

2. The system of claim 1, wherein the paleo-stress region module generates history matched paleo-stress regions including a dynamic behavior or one or more fluid flow assumptions for the one or more paleo-stress regions.

3. The system of claim 2, wherein the machine-readable instructions cause the processor to further:
perform one or more dynamic simulations on the static fracture model with the defined one or more paleo-stress regions.

4. The system of claim 1, wherein the input data includes a borehole image and the structural geology module is to extract sub-seismic lineaments from the borehole image.

5. The system of claim 4, wherein the clustering module is to determine the trends based on the extracted sub-seismic lineaments.

6. The system of claim 1, wherein the structural geology module calculates principal stress magnitudes using a poro-elasticity stress model.

7. The system of claim 6, wherein the clustering module calculates a maximum horizontal stress direction based on the principal stress magnitudes to produce directional trends within the naturally fractured reservoir for defining the one or more paleo-stress regions.

8. A computer-implemented method comprising:
receiving a static fracture model and input data for a naturally fractured reservoir;
performing one or more geological analyses on the static fracture model and input data to extract sub-seismic lineaments and geological properties of the naturally fractured reservoir;
performing one or more clustering analyses on the static fracture model utilizing the sub-seismic lineaments and geological properties to generate trends within the static fracture model;
identifying paleo-stress regions within the static fracture model as natural fracture regions based on the trends; and
performing history matching on the identified paleo-stress regions for mapping historical data for dynamic simulation of the identified paleo-stress regions.

9. The method of claim 8, wherein the one or more geological analyses includes analyzing seismic discontinuities in a three-dimensional (3D) seismic volume to identify the sub-seismic lineaments.

10. The method of claim 8, wherein the one or more geological analyses includes interpreting a borehole image received as the input data to extract a natural fracture type, a dip angle, a dip azimuth, and/or an intensity at well level within the naturally fractured reservoir.

11. The method of claim 10, wherein the borehole image is a seismic image or a resistive image of the naturally fractured reservoir.

12. The method of claim 8, wherein the one or more geological analyses includes calculating structural stress regimes within the naturally fractured reservoir through determination of principal stresses within the naturally fractured reservoir.

13. The method of claim 12, wherein elastic properties, a rock strength, and a pore pressure within a poro-elasticity stress model is used to determine the principal stresses.

14. The method of claim 8, wherein the one or more geological analyses includes generating a structural framework of faults and surfaces to define a volume-based model for identification of paleo-stress regions therein.

15. The method of claim 8, wherein the paleo-stress regions are identified based on maximum horizontal stress direction trends and sub-seismic lineament property trends.

16. A computer-implemented method comprising:
receiving a static fracture model and input data for a naturally fractured reservoir;
obtaining changes in natural fracture orientations within the naturally fractured reservoir based on the static fracture model and the input data;
obtaining variations of maximum horizontal stress directions within the naturally fractured reservoir based on principal stresses therein;
determining one or more paleo-stress regions based on the changes in natural fracture orientations and the variations of maximum horizontal stress directions; and
history matching each determined paleo-stress region to a known quantity of dynamic response based upon a known dynamic response, a historical data set, or a plurality of assumptions for flow characteristics.

17. The method of claim 16, further comprising:
simulating flow within the naturally fractured reservoir to obtain dynamic simulation responses within the static fracture model via history matched paleo-stress regions.

18. The method of claim 17, wherein, the dynamic simulation responses are output to well planning, gas injection, or drilling operation software for optimization of extraction operations in the naturally fractured reservoir.

19. The method of claim 17, further comprising:
causing the dynamic simulation responses within the static fracture model to be displayed on an output device.

20. The method of claim 16, wherein the changes in natural fracture orientations and variation of maximum horizontal stress directions are determined based on properties extracted using an analysis of seismic discontinuities, an interpretation of a borehole image, a calculation of structural stresses, and/or a generation of a structural framework.
